(19) United States
(12) Patent Application Publication
(10) Pub. No.: US 2007/0266409 A1
(43) Pub. Date: Nov. 15, 2007

(54) DATA TRANSMISSION SYSTEM AND METHOD OF TRANSMITTING A DIGITAL SIGNAL FROM A TRIGGER DEVICE TO A SHIFTER DEVICE WITHOUT ANY LOSS OF DATA

(76) Inventor: Ming-Tso Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/383,224

(22) Filed: May 15, 2006

(51) Int. Cl. H04N 7/18

(52) U.S. Cl. 725/78

(57) ABSTRACT

A data transmission system is provided. The data transmission system includes a trigger device, a shifter device, and a gateway device. The trigger device sends a trigger signal in response to a first activation signal. The shifter device sends a shifter signal in response to a second activation signal. The gateway device, which is coupled to the trigger device and the shifter device, receives a data signal, outputs the data signal to the trigger device, pauses outputting of the data signal in response to the trigger signal, and continues outputting the data signal to the shifter device in response to the shifter signal, wherein there is no loss of data between the trigger device and the shifter device.

### BACKGROUND OF THE INVENTION

1. Field of the Invention

The invention relates to digital TVs, and more particularly, to a method and apparatus that can transmit a digital signal from one device to another device without any loss of data.

2. Description of the Prior Art

Digital technology has revolutionized the way we watch live broadcasts. By providing a data stream that can be simultaneously stored and played back, many PVR features such as freeze frame, fast forward, and repeat can be implemented. These features are known as ‘time shift’ features, which allow a user to manipulate a live broadcast as though it were recorded on video. This is enabled by the use of a gateway device, which receives the live broadcast signal, and a storage device, which buffers the live broadcast signal received from the gateway device. When a user watches the live broadcast signal, they are actually watching a signal that is played back from the storage device, and can therefore be manipulated in the same way as a video.

In modern homes, most users have at least two televisions, and a computer that can display multimedia data. In a situation where a user is watching or listening to a digital signal in one location and needs to move to another location (for example, if a television is in the bedroom and another person wishes to sleep), the user will miss some of the data as they move from the first location to the second location. When watching live TV such as news broadcasts or sports games, this lost information can be essential to the user's enjoyment.

### SUMMARY OF THE INVENTION

The present invention aims to utilize the PVR time shift feature to create a new function called ‘spatial shift.’ The utilization of a storage device enables a live broadcast signal to be transmitted from one viewing location to another viewing location without any loss of data between the two locations.

Briefly described, an apparatus for achieving this objective is disclosed according to an embodiment of the present invention. The apparatus comprises: a trigger device, for sending a trigger signal in response to a first activation signal; a shifter device, for sending a shifter signal in response to a second activation signal; a gateway device, coupled to the trigger device and the shifter device, for receiving a data signal, outputting the data signal to the first trigger device, pausing outputting of the data signal in response to the trigger signal, and continuing outputting the data signal to the first shifter device in response to the shifter signal, wherein there is no loss of data between the first trigger device and the first shifter device.

In addition, a method of data transmission is provided according to an embodiment of the present invention. The method comprises: receiving a data signal; outputting the data signal to a first device; generating a first activation signal to generate a trigger signal; pausing outputting the data signal in response to the trigger signal; and outputting the data signal to a second device in response to a shifter signal, wherein there is no loss of data between the first device and the second device.

The present invention utilizes the simultaneous playback/record capability of a digital system to pause data transmission to a first device and transmit the data to a second device without any loss of data between the first and the second device. As data is stored and then transmitted, both the first device and the second device can support PVR functions. The present invention can support broadcast signals, video on demand, and UPnP content.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an embodiment of the present invention.

FIG. 2 is a diagram of the detailed operation of a gateway device, trigger device, and shifter device shown in FIG. 1.

### DETAILED DESCRIPTION

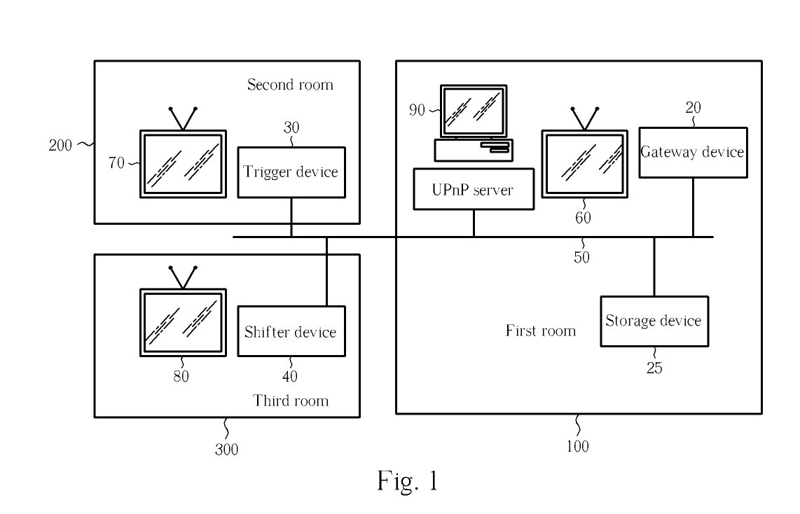

Please refer to FIG. 1. FIG. 1 is a diagram of an embodiment of the present invention. FIG. 1 shows a house having three rooms 100, 200, 300. Each room contains a playback device, such as a digital television or a computer capable of displaying a multimedia signal. Please note the televisions can also display audio data such as digital radio.

The first room 100 comprises a gateway device 20 for receiving a broadcast signal, and a first displaying device 60 coupled to the gateway device 20. The second room 200 comprises a trigger device 30, and a second displaying device 70, coupled to the trigger device 30. The third room 300 comprises a shifter device 40, and a third displaying device 80, coupled to the shifter device 40. The gateway device 20, the trigger device 30, and the shifter device 40 are all connected by means of a home networking LAN 50.

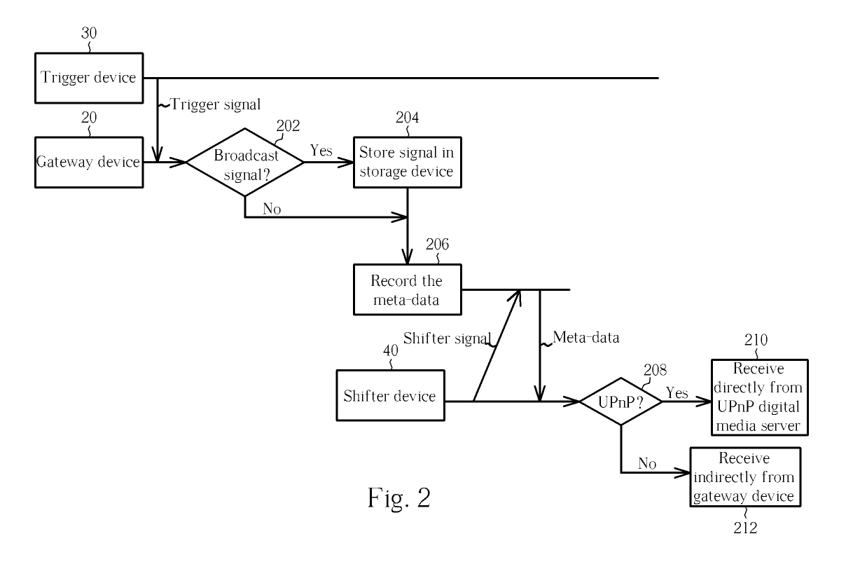

Please refer to FIG. 2 in conjunction with FIG. 1 . FIG. 2 is a diagram of the detailed operation of the gateway device 20, the trigger device 30, and the shifter device 40 shown in FIG. 1 . In an example, a user is in the second room 200 watching a digital TV signal that is received by the gateway device 20 and transmitted to the second displaying device 70. When the user wishes to move to the third room 300 to continue watching the digital TV signal, the user will utilize a remote control to send a first activation signal to the trigger device 30. This first activation signal instructs the trigger device 30 to store meta-data of the digital signal at the moment it was paused, and send this meta-data and a trigger signal to the gateway device 20. In this embodiment, the meta-data is defined to contain information about the playback-paused digital TV signal, including the transport protocol, server address, and the media file path, so the data stream (i.e., the digital TV signal) in the second location can be resumed at exactly the point it was paused in the first location. The trigger signal instructs the gateway device 20 to stop outputting the data stream to the trigger device 30, and to record the meta-data output from the trigger device 30 (step 206). In other embodiments, the gateway device 20 may maintain all related meta-data for the trigger device 30, thus the trigger signal will only instruct the gateway device 20 to stop outputting the data stream to the trigger device 30, without requiring recording the meta-data output from the trigger device 30, as the meta-data is already retained in the gateway device 20. If the aforementioned digital TV signal is a broadcast signal, the digital TV signal will also be recorded to a storage device 25 (steps 202 and 204). It should be noted that the storage device 25 in FIG. 1 is disposed outside the gateway device 20, where the gateway device 20 can access data stored in the storage device 25 via the home networking LAN 50. However, in other embodiments, the storage device 25 can be embedded in the gateway device 20 directly to release the bandwidth occupation of the home networking LAN 50.

When the user reaches the third room 300, he will utilize the remote control to send a second activation signal to the shifter device 40. The second activation signal instructs the shifter device 40 to send a shifter signal to the gateway device 20. On receiving the shifter signal, the gateway device 20 will access the storage device and then forward the requested data stream to the shifter device 40, utilizing the meta-data from the trigger device 30 as a reference. In this way, data stream associated with the digital TV signal will be seamlessly transmitted from one location to another, even though there is a time delay between leaving the first location (e.g. the second room 200) and arriving at the second location (e.g. the third room 300).

Please note that in the above example the trigger device 30 and shifter device 40 are both digital media players (DMP), but either one can also be a software-based application (e.g. a firmware module) that is embedded in the gateway device 20. In other words, a user in the first room 200 can watch a digital TV signal received by the gateway device 20 and transmitted to the first displaying device 60. In this case, the user may move from the first room 100 to the second/third room 200/300, or from the second/third room 200/300 to the first room 100. In this way, the same objective of transmitting a digital signal from one device at a first position to another device at a second position without any loss of data is achieved. Furthermore, as the digital signal is received from a storage device, the PVR functions can still be supported.

The present invention can also support digital signals such as UPnP and video on demand (VOD). In the case of UPnP, the shifter device 40 can utilize the shifter signal to request data directly from a UPnP digital media server 90 (steps 208 and 210). In video on demand, the gateway device 20 is still utilized for receiving and sending the data streams, but the gateway device 20 will further decrypt the protected content and re-encrypt the content into another technology, as video on demand is content protected (steps 208 and 212). In both these cases, the invention will use a RANGE parameter for determining the break point of the digital signal.

The present invention utilizes the simultaneous playback/record capability of a digital system to pause data transmission to a first device and transmit the data to a second device without any loss of data between the first and the second device. As data is stored and then transmitted, both the first device and the second device can support PVR functions. The present invention can support broadcast signals, video on demand, and UPnP content.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission system, comprising:
a trigger device, for sending a trigger signal in response to a first activation signal;
a shifter device, for sending a shifter signal in response to a second activation signal;
a gateway device, coupled to the trigger device and the shifter device, for receiving a data signal, outputting the data signal to the trigger device, pausing outputting of the data signal in response to the trigger signal, and continuing outputting the data signal to the shifter device in response to the shifter signal, wherein there is no loss of data between the trigger device and the shifter device.

2. The system of claim 1, wherein the trigger device and the shifter device are placed at different locations.

3. The system of claim 2, wherein the trigger device or the shifter device is a firmware module of the gateway device.

4. The system of claim 1, further comprising:
a storage device, for buffering the data signal received by the gateway device;
wherein when the gateway device receives the shifter signal, the gateway device accesses the storage device to continue outputting the buffered data signal to the shifter device.

5. The system of claim 1, wherein the trigger device extracts metadata of the received data signal in response to the first activation signal, and sends the metadata to the gateway device; and when the gateway device receives the shifter signal, the gateway device references the metadata to continue outputting the data signal to the shifter device.

6. The system of claim 1, further comprising:
a first playback device, coupled to the trigger device, for playing back the data signal received by the trigger device; and
a second playback device, coupled to the shifter device, for playing back the data signal received by the first shifter device.

7. The system of claim 1, further comprising a home networking LAN for coupling the trigger device and the shifter device to the gateway device.

8. The system of claim 1, wherein the first activation signal and the second activation signal are user commands.

9. The system of claim 1, wherein the gateway device receives the data signal from an Internet multicast delivery, a Radio broadcast delivery, a VOD media server, or a UPnP Media Server.

10. A method of data transmission, the method comprising:
receiving a data signal;
outputting the data signal to a first device;
generating a first activation signal to generate a trigger signal;
pausing outputting the data signal in response to the trigger signal; and
outputting the data signal to a second device in response to a shifter signal, wherein there is no loss of data between the first device and the second device.

11. The method of claim 10 wherein the first device and the second device are placed at different locations.

12. The method of claim 10, wherein the step of pausing outputting the data signal in response to the trigger signal further comprises:
extracting meta-data of the data signal in response to the trigger signal;
wherein the meta-data is referenced for outputting the data signal to the second device.

13. The method of claim 10, wherein the step of outputting the data signal to a first device further comprises playing back the data signal received by the first device, and the step of outputting the data signal to a second device further comprises playing back the data signal received by the second device.

14. The method of claim 10, wherein the trigger signal and the shifter signal are transmitted utilizing a home networking LAN.

15. The method of claim 10, wherein the first activation signal and the second activation signal are user commands.

16. The method of claim 10, wherein the data signal is received from an Internet multicast delivery, a Radio broadcast delivery, a VOD media server, or a UPnP Media Server.
